(19) United States
(12) Patent Application Publication
(10) Pub. No.: US 2026/0203504 A1
(43) Pub. Date: Jul. 16, 2026

(54) Language Model Evaluation Using Key-Phrase Extraction And Text Summarization

(71) Applicant: Oracle International Corporation, Redwood Shores, CA (US)

(72) Inventors: Priyaranjan Pattnayak, Snohomish, WA (US); Amit Agarwal, Seattle, WA (US); Hussain Bohra, Chicago, IL (US)

(73) Assignee: Oracle International Corporation, Redwood Shores, CA (US)

(21) Appl. No.: 19/016,140

(22) Filed: Jan. 10, 2025

(51) Int. Cl. G06F 40/30; G06F 16/35

(52) U.S. Cl. CPC G06F 40/30; G06F 16/35

(57) ABSTRACT

Techniques for evaluating a language model are disclosed herein. A language model is used to generate responses to queries using documents as context. A model evaluator evaluates a query, document, response, triplet to classify the triplet. The triplets are evaluated using key-phrase extraction, summary generation, cross-encoding and similarity scoring for members of the triplets. The triplets are evaluated by generating a summary of the document and evaluating similarity for the summary and response. The triplets are aggregated and/or clustered to determine one or more classifications or attributes based on the scores. Classifications and/or attributes of triplets are used as training data to train and/or fine tune the language model. A classification of a triplet is used to indicate that a chatbot should switch from a first language model to a second language model for generating a subsequent response to a subsequent query.

### TECHNICAL FIELD

The present disclosure relates to language model evaluation.

### BACKGROUND

Large language models (LLMs) are used in various contexts to produce answers to queries and other responses to different prompts. Evaluating the responses generated by a model is important to gauge the accuracy, consistency, and quality of the output generated by the LLM. In cases where a human evaluation occurs, the evaluation is time-consuming and prone to subjectivity and/or human error. In cases where an evaluation is automated, the evaluation often fails to fairly score the accuracy of an answer and results in simplified assessments and/or requires significant computational cost to produce in-depth assessments.

Techniques in this disclosure may address any of the aforementioned flaws, challenges, and/or difficulties. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a language model evaluation system, in accordance with one or more embodiments;

FIG. 2 illustrates example operations for language model evaluation, in accordance with one or more embodiments;

FIGS. 3a-i illustrate example techniques for language model evaluation, in accordance with one or more embodiments;

FIG. 4 illustrates an example machine learning engine, in accordance with one or more embodiments;

FIG. 5 illustrates example operations for machine learning, in accordance with one or more embodiments; and

FIG. 6 illustrates a block diagram of a computer system, in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. General Overview
2. Language Model Evaluation System
3. Language Model Evaluation Operations
4. Example Techniques for Language Model Evaluation
5. Machine Learning Architecture
6. Machine Learning Operations
7. Generative Artificial Intelligence Models
8. Computer Networks and Cloud Networks
9. Microservice Applications
10. Hardware Overview
11. Miscellaneous; Extensions

### 1. General Overview

Embodiments herein evaluate language models based on query, document, response triplets for which the response is at least partly generated by the language model in response to the query and based on the document. Traditional manual scoring is time consuming and introduces subjectivity. Using traditional machine scoring to score such responses is also time consuming, requires an amount of energy and computing resources that increases with complexity of the scoring, is prone to error, and/or requires manual verification.

In embodiments, a model evaluation system accesses a triplet and extracts and/or generates keywords or phrases (e.g., keywords, keyword phrases, key-phrases, etc.) from the query, the document, and the response of the triplet. A key-phrase cross encoder encodes key-phrases, and key-phrase similarity scores are generated for triplets. A summary is generated for the document (or for one or more document chunks) and encoded by a summary cross encoder. Summary similarity scores are generated based on encoded summaries. An aggregator model classifies the triplet based on one or more of a key-phrase similarity score and/or a summary similarity score. The classification of the triplet is used to evaluate whether portion of the response generated by the language model is valid and/or accepted (e.g., determine one or more probabilities, likelihoods, expected values, etc.). In some embodiments, the aggregator model classifies a plurality of triplets and/or performs clustering on the triplets to determine groups and/or attributes. An indication of the triplet groups and/or attributes is provided. The classifications of the triplets and/or the indication of the triplet groups and/or attributes is used as training data to train and/or fine tune a language model.

Applicant notes that this Overview is non-limiting in nature, and that additional embodiments and related combinations of features are described in this Specification and/or recited in the claims.

### 2. Language Model Evaluation System

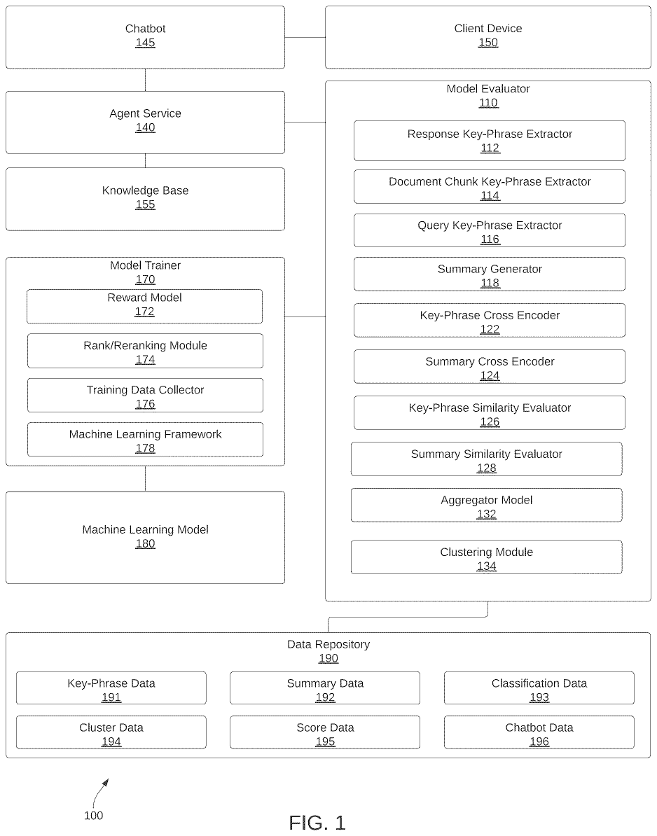

FIG. 1 illustrates an example model evaluator system 100 using key-phrase extraction and/or summary generation, according to embodiments. As shown, the model evaluation system 100 includes a model evaluator 110, an agent service 140, a chatbot 145, a client device 150, a knowledge base 155, an intelligence and analytics module 160, a model trainer 170, a machine learning model 180, and a data repository 190.

In FIG. 1, the model evaluator 110 includes a response key-phrase extractor 112, a document key-phrase extractor model 114, a query key-phrase extractor 116, a summary generator 118, a key-phrase cross encoder 122 a summary cross-encoder 124 a key-phrase similarity evaluator 126, a summary similarity evaluator 128, an aggregator model 132, and a data clustering module 134. Generally, the model evaluator 110 assesses the quality of responses produced by a chatbot and/or a language model used by the chatbot. In various embodiments, content is assessed in relation to user queries, ground truth answers, and/or documents, alignment with a human answer, etc.

In embodiments, one or more key-phrase extractors identify essential terms, such as topics or subjects, within the content of queries, documents, and/or responses. For example, various key-phrase extractors utilize algorithms that isolate terms central to the meaning or theme of a piece of text. These terms represent core ideas, unique entities, or recurring subjects that allow the system to categorize content and establish connections between similar pieces of text using keywords, key-phrases, and/or key-phrases.

In FIG. 1, the response key-phrase extractor 112 determines an essential phrase based on one or more terms that capture the main themes or insights extracted from a response such as a chatbot's generated responses. In embodiments, key-phrase extraction by the response key-phrase extractor 112 involves identifying specific phrases or terms that capture the main idea or focus of the response. For instance, applying natural language processing (NLP) techniques such as tokenization to break the response into smaller components, part-of-speech tagging to identify relevant terms like nouns or noun phrases, and/or syntactic parsing to score or rank phrases by semantic weight.

The document chunk key-phrase extractor 114 performs extraction on documents or document chunks, identifying keywords or phrases that represent core topics, unique identifiers, or other central concepts within the associated corpus of text. In an embodiment, the corpus of text comprises a chunk of a document that was retrieved by a retrieval module. In an embodiment, the chunk of the document is semantically reranked by the ranking model. The ranking model is previously trained and/or is fine-tuned using one or more key-phrase similarity scores, summary similarity scores, and/or triplets. Triplets both having a query and a relevant document chunk and queries having the query (or a different query) and one or more non-relevant document chunks (to be used as a hard negatives reference during training) are included as training data to rank and/or rerank document chunks. For example, a document chunk receives a relatively higher ranking responsive to a score above a threshold, and another document chunk receives a relatively lower ranking responsive to a score below a threshold. In embodiments, the triplets included in the training include a labeled triplet for which a document chunk is considered relevant and a labeled triplet for which a document chunk is considered not relevant.

The query key-phrase extractor 116 extracts key terms from user-submitted queries, isolating words and/or a phrase that signifies a topic, intent or primary interest associated with the query. In embodiments, the key-phrase extraction uses supervised learning models trained on labeled data to classify phrases as relevant key-phrases for one or more queries.

In embodiments, key-phrase extraction by the document chunk key-phrase extractor 114 involves scanning a text corpus of the document (e.g., the document or a chunk of the document) to identify and prioritize phrases that reflect the main topics or themes. In embodiments, the operation applies one or more processing steps such as lemmatization, stop-word removal to eliminate irrelevant content and standardize terms. Statistical methods like TF-IDF (term frequency-inverse document frequency) or clustering algorithms identify phrases with a high degree of uniqueness or relevance within the document. Topic modeling techniques, such as Latent Dirichlet Allocation (LDA), identify thematic phrases based on co-occurrence patterns across sections of the document. Key-phrase extraction from a document identifies a broader overview of themes, as opposed to summarization.

In embodiments, key-phrase extraction from by the query key-phrase extractor 116 includes identifying critical terms that represent the user's intent or the main informational focus of the query. As queries are relatively shorter and contain fewer words and context clues, in some cases, techniques such as keyword spotting, dependency parsing, and semantic role labeling are used to parse the query and identify key action verbs, objects, or modifiers that drive the query's intent. Query expansion methods supplement the query extraction by identifying synonyms or related terms to ensure comprehensive understanding such that a best synonym is chosen for use as a key-phrase term. In some embodiments, expansion methods are performed on responses. In some cases, an expansion method is performed on a response if the response is below a threshold length (e.g., below 50 words, below 250 words, etc.) and/or below a target response size (e.g., less than 50% of a target response size, less than 10% or a target response size, etc.).

In the example, the summary generator 118 includes language models or other summarization modules that generate concise versions of one or more documents or document chunks. For example, the summary generator 118 ingests the entire document, changes and/or defines one or more parameters of a transformer model (e.g. bidirectional encoder representations from transformers, or “BERT” based models) based on the ingested document, and outputs a summary version of the document. The parameters of the transformer model are defined based on the ingested document. The transformer model generates a restatement of the corpus of text based on the defined parameters of the language model, as opposed to being based on extracted keywords or key-phrases. For example, the summary generator 118 creates a summary of a document or document chunk that is conceptually similar to the contents in a more concise form.

In one embodiment, the key-phrase cross encoder 122 and summary cross encoder 124 function to encode extracted terms and generated summaries, respectively, facilitating comparison of these data points. The key-phrase cross encoder 122 converts key-phrases into vector representations that are compared to similar vector embeddings. The summary cross encoder 130 performs encoding on the summary data, transforming the language of the summary into a vector format.

In an embodiment, the key-phrase similarity evaluator 126 calculates the similarity between extracted key-phrases across queries, documents, and responses. This evaluator uses the encoded key-phrases to measure alignment between each segment within the triplet, providing a score that reflects the closeness of terms between user queries, documents, and responses. By quantifying this alignment, the key-phrase similarity evaluator 126 allows the system to determine the validity of a response in relation to the associated query and document in terms of key-phrase similarity.

The summary similarity evaluator 128 assesses the alignment between the summaries generated from the document, the query and/or the answer. This evaluator compares the encoded summary to encodings for the query and response. The summary similarity evaluator 128 measures the key-phrase similarity evaluation by measuring validity of a response in relation to the associated query and document in terms of the language of the query and/or response and the summary of the document.

In various embodiments, the aggregator model 132 classifies one or more triplets based on similarity scores generated by the key-phrase similarity evaluator 126 and the summary similarity evaluator 128. For example, the aggregator model determines a classification of “likely” or “unlikely” (i.e., a binary classification) corresponding to whether, based on key-phrase similarity scores and summary similarity scores, a response of a triplet answers the query of the triplet, or a likelihood percentage (i.e., a score-based or range-based classification) that the response answers the query. The system performs an automatic comparison against a ground truth to determine if the response answers the query. In some cases, a manual validation is optionally performed.

The clustering module 134 organizes triplets into clusters according to score-based classifications. For example, the clustering module 134 evaluates the similarity scores of a query, document, and response triplet, and assigns a classification that reflects the level of alignment among the components.

The clustering module 134 groups triplets into clusters that share similar scores, creating categorized groups that reflect how likely a response is to be valid or accepted. By clustering triplets in this way, the clustering module 134 identifies patterns and attributes that characterize the triplet groups, such as common topics, user intent categories, or response relevance levels for different topics. The attributes of the clusters are used as training data and/or feedback data for training and/or finetuning various machine learning models.

These clusters represent groups of triplets having attribute similarities, facilitating deeper analysis by highlighting which types of queries and documents are, for example, valid or invalid, or consistently well-aligned or less aligned with their responses. The clustered data provides insights into system performance by showing response effectiveness across different types of queries and intents. Additionally, the clustering process supports model training and refinement. The system leverages attributes of the aggregated classifications and/or the clusters to improve future response accuracy and optimize chatbot interactions by using the attributes of the triplets and clusters as training data for various machine learning models, such as language models, ranking models, retrieval models, summary generation models, key-phrase extraction models, encoders, etc.

In FIG. 1, the agent service 140 collects inputs received from a client device, such as a query from a user, and routes these to the chatbot. When the chatbot generates a response, the agent service 140 uses the model evaluator 110 to evaluate the response's validity, acceptability, quality, appropriateness, and/or alignment with a ground truth answer. The agent service 140 determines actions needed to generate a response to a query and utilizes various resources, such as a knowledge base or a language model, to generate responses to queries.

In various examples, the chatbot 145 is a software application designed to simulate human conversation by interacting with users through text or voice inputs. Using natural language processing (NLP), machine learning, and rule-based algorithms, the chatbot understands and responds to questions, provides information, and completes various tasks or transactions. For example, a chatbots is embedded within a website, a messaging application, or a customer support system. After receiving a query from a client device 150, the chatbot 145 generates a response using the agent service 140. This response is then evaluated by the model evaluator 110. The model evaluator 110 gathers new data from interactions between the chatbot 145 and client device 150. The evaluations generated by the model evaluator 110 are utilized by the model trainer 170 to improve the performance of the machine learning model 180.

In the example, the client device 150 represents an endpoint of the chatbot interaction, such as a computer or mobile device from which one or more users access the chatbot. The client devices is used to submit queries to the chatbot. The client device 150 also functions as the display point for chatbot responses, providing an interface for users to interact with the chatbot in real-time.

In various embodiments, the intelligence and analytics module 160 is a set of monitoring and analytical tools that collect and evaluate data on system operations and performance. The module includes logging tools 162, which capture data on user interactions and query patterns. A topic clustering model 164 categorizes queries by themes, identifying patterns across interactions and grouping similar topics. Analytics tools 166 further analyze this data to provide insights into response quality, usage trends, and user engagement. This data serves as a basis for system optimization, facilitating continuous improvement in response accuracy and model relevance.

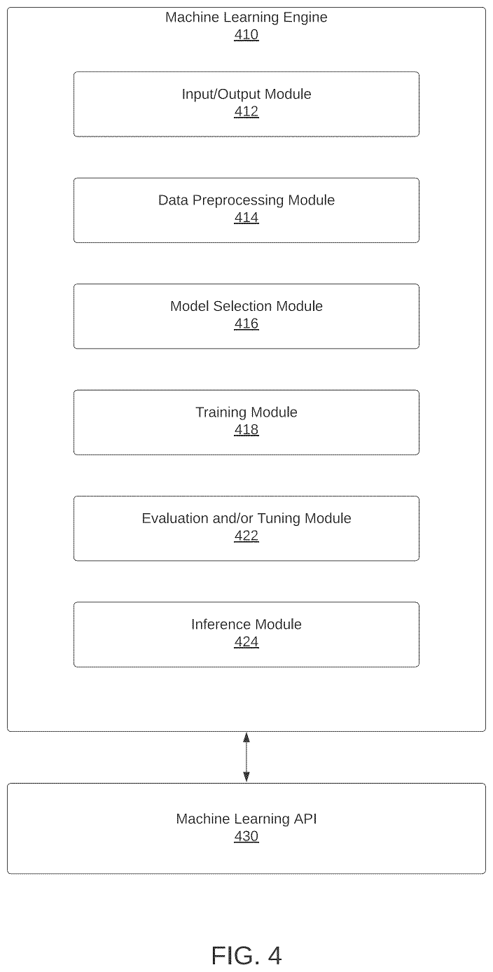

In an embodiment, the model trainer 170 is responsible for adjusting and refining the chatbot's machine learning model by incorporating data from past interactions and system evaluations. The model trainer 170 contains a reward model 172, which reinforces responses that align closely with expected outcomes or ground truths, enhancing response relevance over time. A ranking/reranking module 174 adjusts the ordering of possible responses based on relevance scores, while the training data collector 176 gathers validated response data for model updates. These components work within a machine learning framework 178, which orchestrates the training processes, resulting in a more accurate and responsive chatbot model. In embodiments, one or more components of the model trainer 170 are similar to the machine learning engine 400 of FIG. 4.

In this example, the machine learning model 180 functions as a language model used by the chatbot to generate responses to user queries. In an example, the machine learning model 180 uses data processed by the model evaluator 110 and/or processed by the model trainer 170 to update parameters of the machine learning model 180 used to produce responses that have improved relevance and accuracy. The machine learning model 180 is continuously fine-tuned over time based on new training data to improve response generation.

In embodiments, the data repository 190 is a centralized storage system containing datasets used for chatbot performance, model evaluation, and/or model training. The data repository 190 includes key-phrase data 191, summary data 192, classification data 193, cluster data 194, scoring data 195, and chatbot data 196. In embodiments, the data repository also includes other data from the model evaluator 110 or another data source.

In an embodiment, key-phrase data 191 contains the extracted keywords or key-phrases identified by the key-phrase extractor 120 from user queries, documents, and responses. This dataset organizes significant terms from text content. Key-phrase data 192 serves as a reference that supports processes like response evaluation, clustering, and training. Key-phrase data 192 is used to identify relevant patterns within user queries or chatbot responses for the key-phrases. In various examples, summary data 192 consists of concise versions of documents or document chunks generated by the summary generator 118.

In an embodiment, classification data 193 refers to the classification results generated for triplets by the aggregator model 132 based on the similarity scores. This dataset includes labels or categories assigned to each triplet, such as those indicating alignment strength, ground-truth correctness, and/or usefulness of a document chunk. Classification data 193 reflects the system's assessments of query, document, and response relationships, enabling further analysis and refinement of model training data. These classifications support the training and tuning of machine learning models by indicating response quality trends and identifying areas that benefit from enhanced relevance or specificity.

In embodiments, cluster data 194 contains information related to clusters of triplets generated by the clustering module 134. Cluster data 194 includes attributes of clusters such as centroid location, number of clusters for a set of triplets, cluster density, cluster membership, etc. In various examples, the cluster data 194 is used for analysis, for business intelligence reporting and/or as machine learning model training data.

Score data 195 refers to the scores generated in association with triplets. Score data 195 includes key-phrase similarity scores between components (i.e., queries, chunks, and responses) of the triplets and summary similarity scores between summaries of chunks and responses. Score data 195 also includes aggregate or weighted composite scores derived from the key-phrase similarity scores and/or summary similarity scores. In various examples, the score data 195 is used for analysis, for business intelligence reporting and/or as machine learning model training data.

In various embodiments, chatbot data 196 includes records of interactions between the chatbot and one or more users, including past queries, generated responses, and/or user feedback. This dataset preserves conversation history and details that reflect user engagement, response quality, and recurring topics. Chatbot data 196 includes a log of interactions that the system 100 references to assess response accuracy, track user trends, and/or chatbot performance improvement over time.

In an embodiment, the model evaluator 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the model evaluator 110 includes one or more interfaces. For example, interfaces refer to hardware and/or software configured to facilitate communication between a user and a system. In FIG. 1, an interface is used to facilitate communication between the model evaluator 110, and/or one or more client computing devices. Such an interface renders user interface elements and receives input via user interface elements. Examples of interfaces include a graphical user interface (“GUI”), a command line interface (“CLI”), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

### 3. Language Model Evaluation Operations

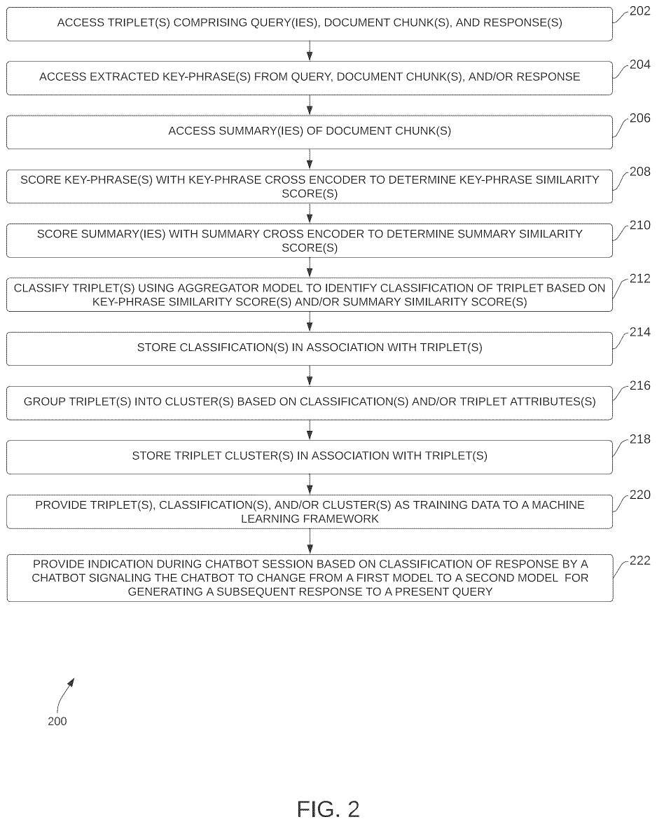

FIG. 2 illustrates example operations for a method 200 of language model evaluation. For example, the method 200 is performed by a system such as the model evaluation system 100 of FIG. 1.

The model evaluator accesses one or more triplets comprising one or more queries, one or more document chunks, and one or more responses (Operation 202). For example, the model evaluator receives a set of one or more triplets containing a user query, document, and a generated response that was generated by a generative model in response to the generative model receiving the query and document as input. In various embodiments, the model evaluator accesses triplets corresponding to previous interactions with a response agent (e.g., an agent model or model deploying one or more reasoning models, retrieval models and/or language models). In other embodiments, a triplet is generated during a live interactive session with a response agent or chatbot. The triplets are scored in different ways to determine how accurately the responses align with the associated queries and/or document(s) to determine attributes of the triplets. In embodiments, the model evaluator accesses a plurality of triplets that are classified and/or aggregated into clusters based on the different scores, associated key-phrases, and/or other attributes of the triplets.

The model evaluator accesses one or more extracted key-phrases from one or more queries, documents, and/or responses (Operation 204). For instance, a key-phrase extractor identifies and selects key-phrases from the query, the document, and the response, for a triplet. The key-phrases correspond to terms or phrases that reflect respective central topics or themes in the components of the triplet. In general, a key-phrase, keyword, or keyword phrase is identified based on textual or semantic analysis using an extractor model that is trained to determine a word, phrase, or word combination, etc., of a corpus of text that has a highest importance score or likelihood of being related to a primary subject, topic, point, or theme of the corpus of text. In embodiments, one or more extracted keywords are concatenated to generate a key-phrase.

In various embodiments, the system generates a key-phrase for the query, a key-phrase for the response, and a key-phrase for one or more chunks of one or more documents. In embodiments, a document and/or document chunk has a larger maximum size than an answer and/or response. In general, a key-phrase includes a subject or topic and/or a modifier or descriptor of the subject or topic and is shorter than a sentence. In contrast, in general, a summary includes one or more sentences having a subject and/or verb. However, extracted key-phrases and/or summaries may be longer or shorter in embodiments.

The model evaluator accesses summaries of the one or more document chunks (Operation 206). In various examples, the model evaluator provides the documents to a summary generator (e.g., an LLM) that creates concise, summarized versions of documents and/or document chunks of a triplet. In embodiments, the target summary size for the summary generation model corresponds to a target response size for a language model used to generate the response. For example, a target response size is between half a target summary size and double a target summary size. Summarizing the document before performing cross-encoding and/or similarity scoring saves resources, and summarizing the document eliminates noisy information in the document.

The model evaluator scores one or more key-phrases with a key-phrase cross encoder to determine one or more key-phrase similarity scores (Operation 208). In embodiments, a key-phrase similarity evaluator compares the encoded key-phrases from the query, document(s), and response, calculating a similarity score based topical or semantic similarity (i.e., similarity in meaning) and/or on an algorithmic or formulaic comparison of the encodings (e.g., cosine similarity or overlap ratio). A key phrase similarity score represents the degree of topic or theme consistency across the triplet elements with reference to one or more key-phrases, providing a quantitative measure based on key-phrase extraction and scoring.

For example, the model evaluator generates a key-phrase similarity score for a query and a document, for a query and a response, and for a response and a document, respectively. In embodiments. In various embodiments, one or more scores of these scores are weighted, aggregated and/or combined to generate an aggregate score. In embodiments, these key-phrase similarity scores and one or more summary similarity scores and used for classification or clustering of sets of triplets. In various embodiments, triplets' are aggregated and/or clustered into classifications or groups based at least in part on key-phrases corresponding to respective triplets. For example, one or more key-phrases for a one or more components of a triplet are stored in association with the key-phrase similarity scores between the key-phrases extracted from components of the triplet.

The model evaluator scores the summary with a summary cross-encoder to determine a summary similarity score (Operation 210). In an example, the model evaluator's summary similarity evaluator compares encoded summaries of the document(s) to the encoded response to determine a summary similarity score for the summary of the document and the response. The summary similarity score is stored in association with and/or separately from the key-phrase similarity score for the summary and response. However, in some embodiments, the key-phrase cross-encoder and the summary cross-encoder generate output that is normalized or otherwise comparable.

The model evaluator classifies the one or more triplets using an aggregator model to identify a classification of a triplet based on a key-phrase similarity score and/or a summary similarity score (Operation 212). For instance, the aggregator model processes the similarity scores to assign a classification that reflects the level of consistency or alignment across the triplet's query, document(s), and response. This classification is used to evaluate the triplet, query, document(s), and or response. In embodiments, the aggregator model classifies a triplet based on the response of the triplet being likely or unlikely to be accepted by a source of the query. For example, the aggregator model classifies the triplet based on whether the response matches (e.g., is similar to) a ground truth answer or if positive feedback is received from the source of the query (or another entity) for the response. The system provides the aggregator model with a number of parameters equal to a sum of (1) the number of similarity scores for query, document chunk pairs; (2) the number of number of similarity scores for response, document chunk pairs; and number of similarity scores for (3) the query, response pair. Continuing the example, attributes for a pair of triplet components include a key-phrase similarity score and a summary similarity score for the pair of components.

The model evaluator stores the one or more classifications in association with the one or more triplets (Operation 214). In various examples, classified triplets are logged with corresponding similarity scores and assigned a classification. Storing the classification with the triplet facilitates further analysis and model training and/or fine-tuning. In some embodiments, a triplet is labeled or flagged based on a classification of the triplet or responsive to a value for a particular similarity score.

The model evaluator groups the one or more triplets into one or more triplet clusters based on the one or more classifications and/or one or more key-phrases (Operation 216). For example, a cluster is generated based on members having a common key-phrase, a same or similar classification, or a same or similar similarity score or set of scores. For example, attributes such as cluster membership, the size of the cluster, the centroid of the cluster, etc., are determined based on key-phrase similarity and/or summary similarity scores for triplets for which one or more component of the triplet has a matching key-phrase.

Clustering triplets based on scores and classifications involves grouping sets of three related items according to similarities in their assigned scores and categorical labels. Common algorithms used for this task include k-means, which partitions triplets into clusters by minimizing variance; hierarchical clustering, which builds a tree-like structure to reveal nested groupings; and DBSCAN (density-based scan), which identifies dense clusters while ignoring or filtering noisy data points and/or noisy regions below a density threshold. In embodiments, similarity scores represent numerical ratings, while classifications represent a type or label. For example, a triplet is classified based on containing a valid response or based on containing an invalid response, a triplet is classified based on containing a response that is aligned with a document or based on containing a response that is not aligned with a document, and so forth. Combining these attributes enables meaningful clusters, supporting tasks like inferencing, analytics, recommendation systems, anomaly detection, and predictive modeling.

These grouped clusters provide structured sets of examples for further analysis, facilitating pattern recognition within the response evaluation process and enabling insights into areas of improvement for model performance. In various embodiments, one or more clusters are visualized in graphical user interface. A centroid, a count of members, a cluster size, and/or other attribute, is visualized for a cluster in the graphical user interface.

The model evaluator stores the one or more triplet clusters in association with the one or more triplets (Operation 218). In embodiments, the model evaluator stores a set of clusters for which the responses include content that was generated by the same generative language model. In other embodiments, the model evaluators stores a set of clusters for which a same retrieval model was used to retrieve the document chunks based on the queries of the triplets. In various embodiments, the clusters are stored in association with a language model, a retrieval model, an agent model, a particular user, etc.

In embodiments, the model evaluator stores a plurality of sets of one or more triplet clusters in association with a plurality of generative models. Attributes of the triplet clusters for a particular model of the plurality of generative models are visualized in a graphical user interface. The plurality of models are evaluated and/or compared based on cluster size and membership for valid responses, invalid responses, key-phrases, and/or other attributes.

In an embodiment, a generative language model used to generate responses in triplets is evaluated by analyzing the size and membership of clusters associated with the triplets. For example, for a set of triplets for which the responses of the triplets were generated by a language model, a cluster of triplets having valid or accepted responses and a cluster of triplets having invalid or not accepted responses are determined via k-means or another clustering technique. Key-phrases are identified based on high membership of triplets having the key-phrases in a cluster of triplets having invalid responses. Responsive to a key-phrase being identified in this way, a system using the language model is adjusted such that a different language model is used to generate responses for subsequent queries related to the key-phrase. For example, a chatbot deploys a plurality of language models such that a language model of the plurality of language models is selected based on a key-phrase of the query. A model is selected from the plurality of models based on a cluster of triplets having valid responses generated by the model having a highest membership of triplets including the key-phrase.

The model evaluator provides one or more triplets, classifications, and/or triplet groups as training data to a machine learning framework (Operation 220). For example, the model evaluator forwards the classified and clustered triplets to a machine learning framework, which utilizes this data to refine one or more language models. Providing the training data to the machine learning framework supports facilitates adjustments to the parameters of the model that enhance the model's accuracy and relevance in generating responses.

The model evaluator provides an indication to the chatbot based on the one or more classifications by signaling the chatbot to change from a first model to a second model for generative a subsequent response to a present query (Operation 222). In some embodiments, the model evaluator transmits a signal to the chatbot, indicating that the chatbot's language model should change to a different model or should adjust based on a key-phrase similarity score and/or a summary similarity score (or a combination). In embodiments, the chatbot changes based on a key-phrase extracted from a query, a cluster membership associated with the key-phrase, a topic of the query, etc. The chatbot response generation is updated based on this information, for example to improve accuracy or alignment by using a different large language model to generate response content. In various embodiments, a set of triplets includes the queries, document chunks, and responses associated with a particular conversation. The indication to change models is provided to the chatbot based on attributes of the set of triplets and/or responsive to a classification and/or a clustering of the set of triplets.

### 4. Example Techniques for Language Model Evaluation

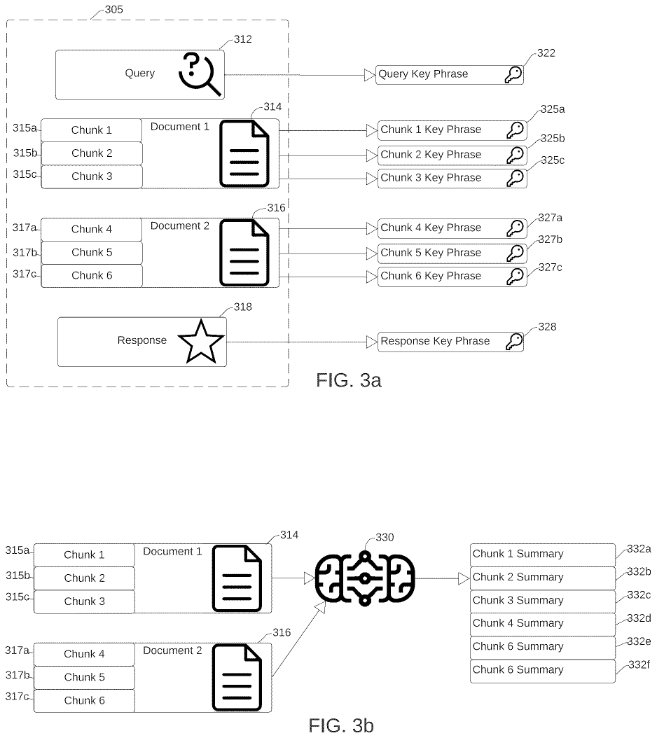

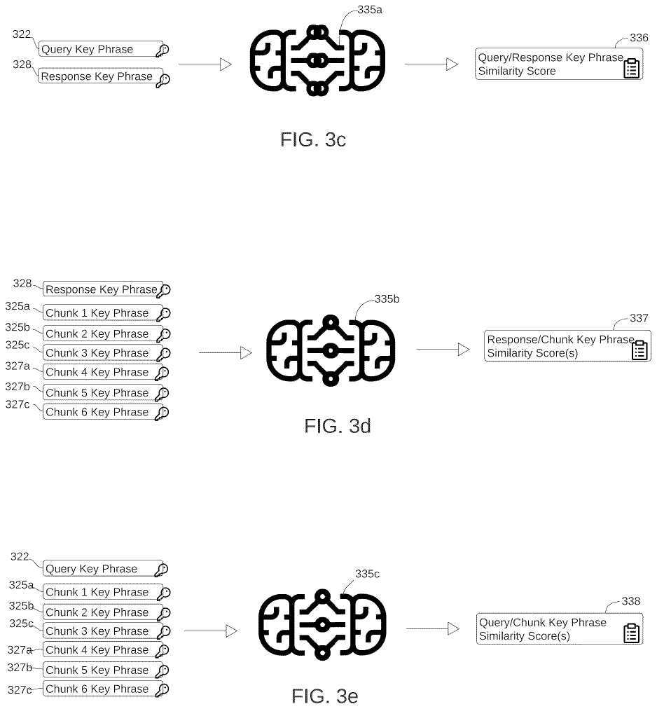

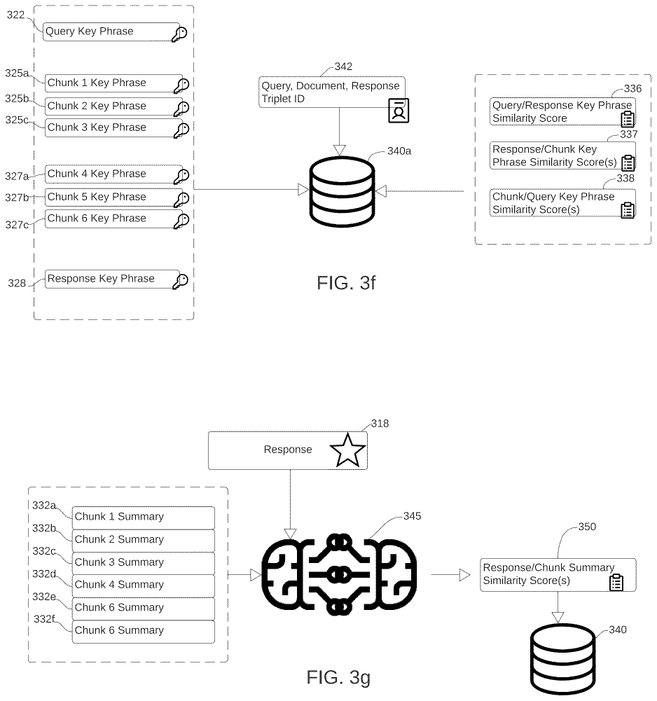

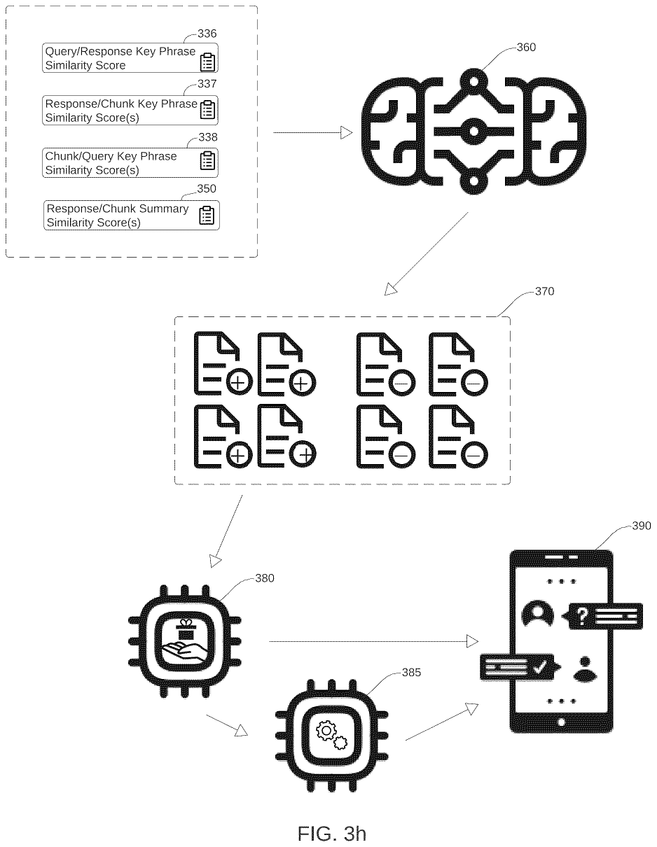

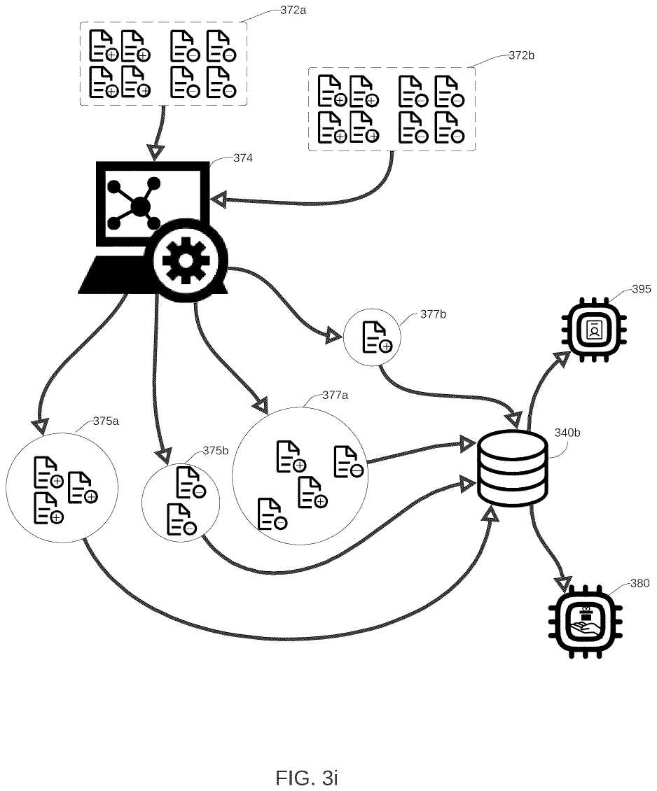

FIGS. 3a-i illustrate example techniques for evaluating a language model based on a response generated using the language model, in accordance with one or more embodiments. In FIG. 3a, a triplet consisting of a query 312, a first document 314, a second document 316 and a response 318 are used to generate key-phrases (e.g., or key words, keyword phrases, etc.).

In embodiments, a model evaluator processes the query 312 to identify a query key-phrase 322. The first document 314 is divided into a first chunk 315a, a second chunk 315b, and a third chunk 315c, and the second document 316 comprises a first chunk 317a, a second chunk 317b, and a third chunk 317c. The key-phrase extractor 120 scans chunks within the documents 314, 316 to isolate and produce document chunk key-phrases for individual chunks.

In the example, a first document 314 and a second document 316 are shown with three chunks. However, in other embodiments, any number of documents having any number of chunks are included in a triplet. For example, a triplet includes an answer that was generated based on any number of document or document chunks. The system generates the key-phrases based on these document chunks.

In the example, a query key-phrase 322 is generated from the query 312. Also in the example, a first document key-phrase 325a, a second document key-phrase 325b, a third document key-phrase 325c, a fourth document key-phrase 325d, a fifth document key-phrase 325e, and a sixth document key-phrase 325f are generated based on the first chunk 315a of the first document 314, the second chunk 315b of the first document 314, the third chunk 315c of the first document 314, the first chunk 317a of the second document 316, the second chunk 317b of the second document 316, and the third chunk 317c of the second document 316, respectively. As shown, a response key-phrase 328 is generated from the response 318.

In FIG. 3b, the system generates a first document chunk summary 332a, a second document chunk summary 332b, a third document chunk summary 332c, a fourth document chunk summary 332d, a fifth document chunk summary 332e, and a sixth document chunk summary 332f based on the first chunk 315a of the first document 314, the second chunk 315b of the first document 314, the third chunk 315c of the first document 314, the first chunk 317a of the second document 316, the second chunk 317b of the second document 316, and the third chunk 317c of the second document 316, respectively. In embodiments, the system generates a document chunk summary by providing a document chunk to a summary model 330.

Generating a summary from a document chunk differs significantly from extracting keywords or key-phrases, as each approach employs distinct methods and produces unique results. One approach to summarizing a document chunk is abstractive summarization. This technique uses language models, such as transformer-based models, to generate a condensed version of the content by reformulating the main ideas into coherent sentences, sometimes using novel phrasing. Abstractive summaries are newly generated text that captures the essence of the original chunk in a shorter form.

Another method is extractive summarization, which selects and ranks key sentences or phrases directly from the chunk without altering them. Models trained in identifying essential sentences within the text prioritize those sentences that best represent the main content, resulting in a concise collection of original text that conveys the core ideas.

A third summarization technique, sentence scoring and compression, involves scoring sentences by relevance, uniqueness, and redundancy within the chunk. The highest-ranking sentences are retained, and additional compression techniques may merge or condense these sentences further, preserving key information while eliminating repetition. This approach creates a shorter, direct summary of the chunk's primary ideas in a compact format.

In contrast, keyword or key-phrase extraction focuses on identifying specific terms or short phrases that represent important topics or subjects within the chunk. Unlike summarization, keyword extraction does not aim to reformulate or express these ideas in sentences; instead, it highlights isolated terms or phrases that are central to the text's meaning. Summaries generally provide a more comprehensive understanding of a chunk's content by incorporating sentence structure and context, whereas key-phrases offer a quicker, more focused view of the topics covered that may not include the full context but is suitable for indexing.

In FIG. 3c, a first key-phrase cross encoder 335a generates a query/response key-phrase similarity score 336 by evaluating the relationship between the response key-phrase 328 and one and the query key-phrase 322. The query/response key-phrase similarity score 336 indicates how aligned a response is to the query in terms of key-phrase similarity.

In FIG. 3d, the second key-phrase cross encoder 335b generates a response/chunk key-phrase similarity score 337, by evaluating the relationship between the response key-phrase 328 and one or more of the document chunk key-phrases 325a-c, 327a-c. The response/chunk key-phrase similarity score 337 indicates how aligned a response is to the chunk in terms of key-phrase similarity.

In FIG. 3e, a third key-phrase cross encoder 335c generates a query/chunk key-phrase similarity score 338. The cross encoder 335c evaluates the query key-phrase 322 with one or more document chunk key-phrases 325a-c, 327a-c, producing the query/chunk key-phrase similarity score 338. The query/chunk key-phrase similarity score 338 indicates how relevant a document chunk is to the query in terms of key-phrase similarity. Although three cross encoders 335a-c are illustrated, more or less cross encoders are used in embodiments. For example, in an embodiment, one cross encoder is used for generated key phrase similarity scores. In another embodiment, a plurality of cross encoders are used for a plurality of queries, responses, and/or document chunks based on a type or topic of the triplet.

In FIG. 3f, the query key-phrase 322, the document chunk key-phrases 325a-c for the first document 314, the document chunk key-phrases 327a-c for the second document, and the response key-phrase 328 are stored in a datastore 340a. The query/response key-phrase similarity score 336, the response/chunk key-phrase similarity score 337, and the query/chunk key-phrase similarity score 338 are also stored in the datastore 340a. An identifier 342 for the triplet 305 is also stored in the datastore 340a in association with the query key-phrase 322, the document chunk key-phrases 325a-c for the first document 314, the document chunk key-phrases 327a-c for the second document, and/or the response key-phrase 328.

In various embodiments, the document chunk key-phrases 325a-c for the first document 314, the document chunk key-phrases 327a-c for the second document, the response key-phrase 328, the key-phrase similarity scores 336, 337, 338 and/or other data or metadata for the triplet are stored in a datastore 340a. In various embodiments, the data is used for processing and analysis based on keywords or key-phrases.

In FIG. 3g the system provides the document chunk summaries 332a-f as input to a summary cross encoder 345. The summary cross encoder 345 generates a response/chunk summary similarity score 350. For example, the summary cross encoder 345 determines how closely related one or more document chunk summaries 332a-f are to the response 318 and outputs a response/chunk summary similarity score 350 using semantic similarity between the response and the one or more document chunk summaries 332a-f. In another example, the summary cross encoder 345 generates scores for combinations or groupings of document chunk summaries associated with a particular source and/or a particular document.

In FIG. 3h, the query/response key-phrase similarity score 336, the response/chunk key-phrase similarity score 337, the query/chunk key-phrase similarity score 338, and the response/chunk summary similarity score 350 are provided to an aggregator model 360. The aggregator model 360 determines one or more classes and/or scores for a triplet. In embodiments, the aggregator model 360 determines one or more classes and/or scores for a plurality of triplets. For example, triplets of the plurality of triplets are clustered by keyword, topic, query source, etc., and according to the different scores for response/chunk key-phrase similarity scores, chunk/query key-phrase similarity scores, the response/chunk key-phrase similarity scores, and response/chunk summary similarity scores.

In general, an aggregator model combines various input scores to classify an input by interpreting patterns, similarities, or specific thresholds indicated by each score. For instance, when evaluating a triplet, the aggregator model analyzes the query/response key-phrase similarity score, the response/document chunk key-phrase similarity score, the query/document key-phrase similarity score, and one or more response/document chunk summary similarity scores.

The aggregator model evaluates the scores and assigns one or more classifications based on various criteria. Various classifications include classes, groups, or clusters related to relevance or accuracy, such as “highly relevant,” “partially relevant,” “irrelevant,” “valid,” or “invalid,” as well as classifications related to topics, key-phrases, document source, query source, and/or other attributes of a triplet. For example, the model classifies the input as “highly relevant” if scores exceed certain thresholds, or “partially relevant” if some but not all scores meet criteria. The aggregator model evaluates the scores based on a probability that a particular response to a particular query will be accepted or rejected based on one or more classifications or criteria. In embodiments, the aggregator model aggregates triplets into classifications based on one or more threshold probabilities that a particular response to a particular query will be accepted or rejected (e.g. more likely accepted or more likely not accepted, less than 15% likely to be accepted, more than 85% likely, more than 95% likely, etc.).

In FIG. 3h, the aggregator model generates evaluation data 370 in the form of classified triplets that are received by a reward model 380. The reward model 380 trains, fine-tunes, or optimizes a language model 385 using the classified triplets, (e.g., an agent model, a generative LLM, a query response model, etc.). In embodiments, the evaluation data 370 is used as training data to fine-tune a retrieval model, a ranking model, a reranking model, and/or one or more embedding models used by an agent model to retrieve the document in response to the query. In embodiments, the evaluation data includes a probability that a particular answer to a particular query is accepted or rejected based on the cluster membership(s) associated with the query.

In the example, the language model 385 is used to generate response content for a chatbot application accessed by a client device 390. Feedback is collected based on the presence and/or contents of one or more subsequent queries, feedback indicating completion of the conversation, direct feedback from the user (e.g., positive “thumbs up” or negative “thumbs down” feedback, or a numbered score within a range), etc. In embodiments, this feedback is also received by the reward model 380 and/or used as training data to fine-tune the language model 385. In some embodiments, the system changes the language model used to generate responses for the chatbot from the language model 385 to a different language model based on the evaluation data 370 and/or other feedback.

In FIG. 3i, a first set of classified triplets 372a and a second set of classified triplets 372b are inputted into a clustering module 374. In this example, the system clusters a plurality of triplets into a plurality of groups or clusters including a first cluster 375a of members of the first set of triplets 372a, a second cluster 375b of members of the first set of triplets 372a, a first cluster 377a of members of the second set of triplets 372a, and a second cluster 377b of members of the first set of triplets 372a. In various embodiments, clusters are determined using key-phrase similarity scores, summary similarity scores, and attributes of the triplets (e.g., associated key-phrases for a query, document chunk, or response, query source, meta data, etc.).

In the example, a first set of queries and a first set of document chunks are provided to a first model to generate a first set of responses to the queries based on the chunks. The first set of queries and the first set of document chunks is provided to a second model to generate a second set of responses to the first set of queries based on the first set of chunks. The first set of triplets 372a includes the first set of queries, the first set of document chunks, and the first set of responses. The second set of triplets 372b includes the first set of queries, the first set of chunks, and the second set of responses.

In some embodiments, a first retrieval model is used to retrieve the first set of document chunks based on the first set of queries and a second retrieval model is used to retrieve a second set of document chunks based on the first set of queries. In this example, the second set of triplets includes the first set of queries, the second set of document chunks, and a second set of responses generated by the first language model based on the first set of queries and the second set of document chunks.

In some embodiments, a first agent model deploys a first retrieval model and a first generative language model; and a second agent model deploys a second retrieval model and a second generative language model. In this example, the first set of triplets 372a includes the first set of queries, a first set of document chunks retrieved by the first agent model using the first retrieval model, and a first set of responses generated by the first agent model using the first generative language model based on the first set of document chunks. In this example, the second set of triplets includes the first set of queries, a second set of document chunks retrieved by the second agent model using the second retrieval model, and a second set of responses generated by the second agent model using the second generative language model based on the second set of document chunks.

In various embodiments, sets of triplets for one or more models are clustered by score, association with one or more key-phrases, query sources, and/or other attributes. The system provides an indication of groups associated with attributes of a triplet for which one or more triplets include irrelevant or invalid responses. In this way, the system evaluates the relevance or accuracy of the model used to generate the response granularly by topics, key-phrases, document source, query source, etc. The various scores provide actionable insights or information about triplets and/or clusters. A low chunk/query key-phrase similarity score for a key-phrase or topic of a cluster that has high other similarity scores for the key-phrase or topic indicates that document retrieval, as opposed to natural language generation, is more likely to introduce error, inaccuracy, hallucination, or misalignment.

In the example of FIG. 3i, the first model and second model are evaluated by comparison of classifications of and/or clusters generated from the first set of triplets 372a and the second set of triplets 372b. In FIG. 3i, the first cluster 375a includes three triplets that are classified positively (e.g., received positive feedback, are similar to a ground truth, or were accepted by a user). The first cluster 377a includes two triplets that are classified negatively, and two triplets that are classified positively. The first cluster 375a and the first cluster 377a are both associated with a same key-phrase in this example. The responses of the triplet members of cluster 375a were generated using the first model. The responses of the triplet members of cluster 377a were generated using the second model. In some embodiments, the first model is selected for deployment associated with the same key-phrase based on having more positive responses in the respective cluster for the first model associated with that same key-phrase. Also, the second model is flagged or labeled responsive to including negative response cluster members. Further, the second model is flagged or labeled responsive to including more cluster members than the first cluster 375a, as this indicates the second model may have hallucinated (or, in some embodiments, that a retrieval model retrieved an incorrect chunk) and introduced into the second set of triplets 372b a keyword that is not present in the first set of triplets 372a.

Also in the example, the second triplets cluster 375b includes two negative-response triplets and the second triplet cluster 377b includes one positive-response triplet. In the example, the cluster 375b and the cluster 377b are both associated with a particular user or query source. In this example, the second model is selected for generating subsequent responses for the particular user based on the cluster 377b having a positive triplet member and the cluster 375b having no positive triplet members and/or having two negative triplet members.

The qualities of the clusters for a particular attribute or combination of attributes provide insight into a model's performance for the attribute or combination of attributes. For clusters associated with two different models that share an attribute such as a key-phrase, source, or query type (e.g., a service request, technical support, information retrieval, etc.), the attributes of the cluster is used to make a direct comparison or selection between two or more models. In the example, the first model is selected by the system for generating subsequent responses having the key-phrase based on the qualities of the clusters for that key-phrase for the first and second model. In embodiments, the clusters are visualized in a GUI for graphical.

In various embodiments, the triplet and cluster data is stored in a data storage location. In the example, the data for the sets of triplets 372a, 372b, and the clusters 375a, 375b, 377a, 377b, is stored in a data storage 340b. In embodiments, the data in the data storage 340b is accessible by the reward model 380. The reward model 380 is used to train one or more agent models 395, generative language models (such as model 385), and/or document chunk retrieval models. The data is also used by an agent model to select one or more generative language models and/or document chunk retrieval models to respond to a present user query based on the qualities of the clusters and the query source, topic, or an associated key-phrase included in the query and/or a retrieved document chunk.

### Example Methodology for LLM Response Evaluation

Methodology:

Steps:

Generated response is henceforth noted a GR, while document chunk is noted as DC and user Query as Q.

Extract & Generate Key-phrase(KP)s: 1) from GR referred as GR-KP; 2) from every DC referred as DC-KP; and 3) from Q referred as Q-KP.

Generate Summary(GS) for DCs retrieved for a given Q.

Apply trained cross-encoder model that takes the above key phrases and summary as inputs, processes them and generates a similarity score (for example based on whether the key-phrases and summary share a similar topic)

Key-phrase similarity cross-encoder:

GR-KP and Q-KP: The similarity score tells us whether GR is talking about the same topics as the Q. Responsive to this similarity score being below a threshold, the model is determined to be misaligned with the query. This triplet is stored with an indication of the score being below the threshold and is used as a negative instance in training data. Training data collection is automatic in some embodiments.

GR-KP and DC-KP: The similarity score tells us whether GR is aligned with the same topics as the DC. Responsive to this similarity score being below a threshold, the model is determined to be answering from its memory leading to possible hallucination. This triplet is stored with an indication of the score for use as negative data, such as for training and/or benchmarking LLMs.

Q-KP and DC-KP: Responsive to this similarity score being below a threshold, the model is determined to be using DC that are not related to the Q, indicating unrelated information retrieval. This triplet is stored with an indication of the score for use as negative data for training and benchmarking retrieval, ranking, and reranking models.

Summary similarity cross-encoder: Responsive to this similarity score being below a threshold, the model is determined to be producing answers that are semantically unrelated to the documents. DC's whose GS is semantically similar to GR should have high similarity between GR-KP and DC-KP. Responsive to this similarity score being below a threshold, the system flags the response for human validation. However, for DC's whose GS is not semantically similar to GR, responsive to this similarity score being above a threshold, the system flags the response for human validation.

In general, using summaries instead of whole documents saves computational cost of the system and produces more accurate results. GS's generally have similar size as GR. A relatively large DC traditionally causes skewed results.

In an example, a GS is created during data ingestion. In embodiments, a GS for a chunk is stored as metadata in Open Search. In various embodiments, a DC-KP and Q-KP similarity cross-encoder score, a DC-KP and GR-KP similarity cross-encoder score, a Q-KP and GR-KP similarity cross-encoder score, and/or a summary similarity cross-encoder score are fed to a classification model for an aggregate score computation, to evaluate the acceptance probability of the LLM Response.

### Example Classifier Model

In an example, a trained classifier (Agg Model) predicts probabilities of acceptance (e.g., helpful vs not-helpful) of a response. Below are the features for this model:

Key-Phrase Similarity Scores: Features of key-phrase similarity scores include features for the DC-KP and Q-KP score, the DC-KP and GR-KP score, and/or the Q-KP and GR-KP score. In embodiments, there are a plurality of chunks in a document resulting in similarity scores for a plurality of chunks for DC-KP and Q-KP, and similarity scores for a plurality of chunks for DC-KP and GR-KP, resulting in a number N scores each for DC-KP and Q-KP and DC-KP and GR-KP across the number N DCs. In this example, a total number of key-phrase similarity scores T equals the sum of the number of these scores (T=1+N +N, for N DCs).

Summary Similarity Scores: Features of summary similarity scores are also numbered N for the number of similarity scores between a N GSs for N DCs and the GR. In this example, a total number of summary similarity scores T equals the number of document chunks (T=N, for N DCs).

In an example, a model has a maximum limit of features. For example a model supports a maximum of thirty-one (31) features so a maximum of ten document chunks are retrieved and/or used. ten document chunks (max(N)=10). In this example, for ten document chunks, there are thirty-one key-phrase similarity features (N=10→T=1+10+10 =21) and ten summary similarity features (N=10, →T=10). More than ten document chunks causes the number of features to exceed the maximum. The number of document chunks is selected based on the maximum number of features for a model, in some embodiments.

Responsive to a number of documents chunks being less than the maximum, values for the remaining features are assigned as negative one or not a number (−1 or NaN [not-a-number]). For example, in the case that thirty-one features are the maximum, and less than ten document chunks are fetched (resulting in less that thirty-one features), the features that are not provided values by the document chunks are assigned a value of negative one.

In an example, the classifier is trained on historical user feedback (helpful vs not-helpful) and previous conversations. The feedback is used as labels for classification. For conversations for which feedback was received, the feedback is used to train the model while the features are computed.

In some embodiments, the system deploys pseudo labels and corresponding data from user feedback for LLM Content Management System to further improve the accuracy of the aggregator model, In embodiments, the system generates synthetic data as part of knowledge distillation to use an LLM as a judge to classify conversations. In some embodiments, the system generates synthetic data responsive to human feedback not being present or missing.

In the example, with training, the system is able to predict a user behavior or response with an Accuracy of 97%. The data from training the aggregator model is continuously updated to handle shift in user behavior/pattern. In an aggregation and decision layer, the system includes post-processing to filter negative data. The systems collects positive and negative data, which are used to train a reward model that is used during live conversation, for example to provide a quality score. In embodiments, a separate offline system performs deeper analysis. Negative data and positive data are used for re-ranker training.

In embodiments, a user or user device has an option to choose to opt out from reward model tuning during conversations to reduce cost and reduce latency. In embodiments, one or more generated KPs are stored and/or used for further analysis such as to analyze triplets for concept drifts in user questions, concept drift in documents being generated, pain point identification, bottleneck for users, etc.

In embodiments, themes are generated out of the positive (helpful) and negative (not-helpful) datasets, and clustering is performed separately on question set followed by on an answer set. In this example, the questions/answers are grouped clusters for human analysis by leveraging a pre-built topic clustering framework. Output from this clustering results in grouping of Questions and Answers into meaningful topics, which is then fed into various analytics models.

Both positive and negative datasets are joined with chatbot session data in to add more dimensions for training and fine-tuning operations, for example using logging analytics. Human analysis involves analyzing top clusters for not-helpful Questions and Answers, and identifying areas of improvement, including adding new documentation, improving processes or discoverability of help articles for customers in some embodiments.

### 5. Machine Learning Architecture

FIG. 4 illustrates a machine learning engine 400 in accordance with one or more embodiments. As illustrated in FIG. 4, machine learning engine 400 includes input/output module 420, data preprocessing module 414, model selection module 416, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 400. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 400.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 416 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

### 6. Machine Learning Operations

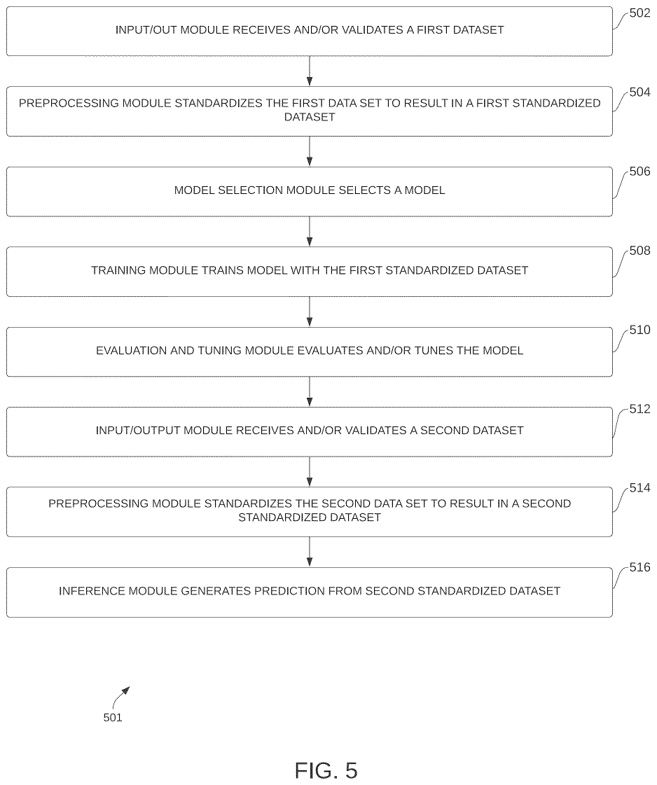

FIG. 5 illustrates a set of machine learning operations 500. In embodiments, one or more operations of the set of operations 500 is performed by a machine learning engine such as machine learning engine 400. In an embodiment, input/output module 420 receives a dataset intended for training (Operation 502). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 508). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 510). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 430 processes the new data set intended for inference, using the trained and tuned model (Operation 516). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as/submitData facilitate the submission of new data for processing, while/retrieveResults is designed for fetching the outcomes of data analysis or model predictions. The MLE API may also include endpoints like/updateModel for model modifications and/rainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. A “SoftMax” function, or normalized exponential function, converts a vector of real numbers into a probability distribution of possible outcomes. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 416, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

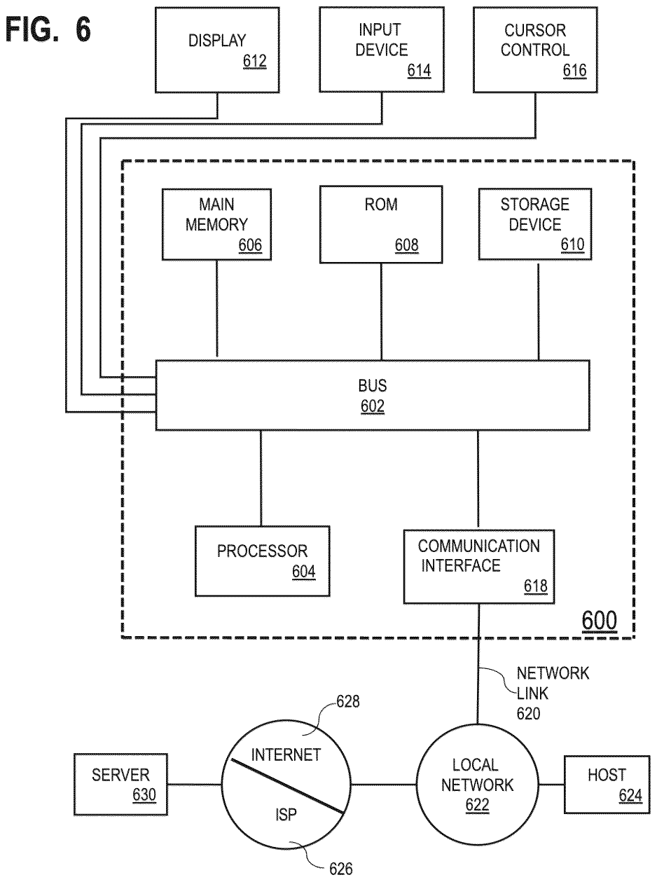

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method, comprising:
accessing a triplet comprising a plurality of components including: a query, a document chunk, and a response, the response including content based on: an output generated by a language model in response to the query;
extracting a first key-phrase from a first component of the triplet;
extracting a second key-phrase from a different component of the triplet;
generating a summary of the document chunk;
generating a key-phrase similarity score using a key-phrase cross encoder to cross-encode the first key-phrase and the second key-phrase into the key-phrase similarity score;
scoring the summary using a summary cross encoder to cross-encode the summary and the response to generate a summary similarity score;
generating feedback data for the output based on the key-phrase similarity score and the summary similarity score; wherein
the method is performed on at least one computing device comprising a processor.

2. The method of claim 1, further comprising:
accessing an output of an aggregator model generated based on the key-phrase similarity score and the summary similarity score;
classifying the triplet based on the output; and
providing the classification of the triplet as training data to the language model.

3. The method of claim 2, further comprising:
providing the feedback data as input into the aggregator model, the aggregator model having been previously trained to predict probabilities that responses to queries are accepted by sources of queries based on synthetic training data and human feedback data.

4. The method of claim 1, wherein:
the document chunk comprises a chunk of a document identified by a retrieval model in response to the query, the method further comprising:
providing the feedback data as training data to the retrieval model.

5. The method of claim 1, wherein:
the output is generated by providing the query and the document chunk to the language model; the method further comprising:
providing the feedback data as training data to the language model.

6. The method of claim 1, wherein:
the query comprises a chatbot query and the model comprises an agent model; the method further comprising:
generating output of the agent model by:
providing the query to a retrieval model to receive an identification of a document, the document including the document chunk;
retrieving the document chunk based on the identification;
providing the document chunk and the query to a generative language model to generate the output; and
providing the feedback data to a reward model for the agent model.

7. The method of claim 1, wherein:
the key-phrase similarity score is a query-response key-phrase similarity score, the method further comprising:
extracting the first key-phrase from the query;
extracting the second key-phrase from the response;
extracting a third key-phrase from the document chunk;
generating the query-response key-phrase similarity score;
generating a query-document chunk key phrase similarity score using the key-phrase cross encoder to cross-encode the first key-phrase and the third key-phrase;
generating a response-document chunk key phrase similarity score using the key-phrase cross encoder to cross-encoder the second key-phrase and third key-phrase; and
storing, in association with the triplet, the first key-phrase, the second key-phrase, the third key-phrase, the query-document chunk key phrase similarity score, the response-document chunk key phrase similarity score and the response-document chunk key phrase similarity score.

8. The method of claim 1, wherein:
the document chunk is a first document chunk of a plurality of document chunks of a plurality of documents associated with the triplet;
the method further comprising:
generating a plurality of summaries of the plurality of documents and scoring the plurality of summaries using one or more summary cross encoder models to generate one or more summary similarity scores.

9. The method of claim 1, wherein:
the document chunk comprises a first chunk;
the method further comprising:
generating a first summary for the first chunk and one or more additional summaries for one or more additional chunks; and
scoring the first summary and the one or more additional summaries using a summary cross encoder model to generate the summary similarity score and one or more additional summary similarity scores.

10. The method of claim 1, wherein:
the triplet is a first triplet of a plurality of triplets;
the method comprising:
clustering the plurality of triplets using the one or more key-phrases.

11. The method of claim 1, further comprising:
clustering the triplet into a cluster based on the one or more key-phrases; and
identifying a count of a number of triplet members in the cluster corresponding to a key-phrase.

12. The method of claim 11, further comprising:
clustering the triplet into a cluster based on an attribute of the triplet; and
indicating, for the cluster, in a graphical user interface, at least one of: a count of triplet members in the cluster; a trend in the count of triplet members, a cluster centroid location, cluster centroid information, cluster metadata, a cluster query class, a cluster document type, a cluster document source, a cluster query source, and a cluster query topic.

13. The method of claim 1, wherein:
the key-phrase similarity score is computed using a semantic similarity between a first key-phrase and a second key-phrase.

14. The method of claim 1, wherein:
the output is a first output and the language model is a first language model;
the method further comprising:
indicating a change from the first language model to a second language model responsive to the feedback data for the first output being negative; and
instructing the second language model to generate a second output responsive to a subsequent query.

15. A system comprising:
at least one device including a hardware processor;
the system being configured to perform operations comprising:
accessing a triplet comprising a plurality of components including: a query, a document chunk, and a response, the response including content based on: an output generated by a language model in response to the query;
extracting a first key-phrase from a first component of the triplet;
extracting a second key-phrase from a different component of the triplet;
generating a summary of the document chunk;
generating a key-phrase similarity score using a key-phrase cross encoder to cross-encode the first key-phrase and the second key-phrase into the key-phrase similarity score;
scoring the summary using a summary cross encoder to generate a summary similarity score;
generating feedback data for the output based on the key-phrase similarity score and the summary similarity score.

16. The system of claim 15, the operations further comprising:
accessing an output of an aggregator model generated based on the key-phrase similarity score and the summary similarity score;
classifying the triplet based on the output;
providing the classification of the triplet as training data to the language model; and
providing the feedback data as input into the aggregator model, the aggregator model having been previously trained to predict probabilities that responses to queries are accepted by sources of queries based on synthetic training data and human feedback data.

17. The system of claim 15, wherein:
the document chunk comprises a chunk of a document identified by a retrieval model in response to the query; and
the output is generated by providing the query and the document chunk to the language model; the operations further comprising:
providing the feedback data as training data to the retrieval model; and
providing the feedback data as training data to the language model.

18. The system of claim 15, wherein:
the query comprises a chatbot query and the model comprises an agent model; the operations further comprising:
generating output of the agent model by:
providing the query to a retrieval model to receive an identification of a document, the document including the document chunk;
retrieving the document chunk based on the identification;
providing the document chunk and the query to a generative language model to generate the output; and
providing the feedback data to a reward model for the agent model.

19. The system of claim 15, wherein:
the key-phrase similarity score is a query-response key-phrase similarity score, the operations further comprising:
extracting the first key-phrase from the query;
extracting the second key-phrase from the response;
extracting a third key-phrase from the document chunk;
generating the query-response key-phrase similarity score;
generating a query-document chunk key phrase similarity score using the key-phrase cross encoder to cross-encode the first key-phrase and the third key-phrase;
generating a response-document chunk key phrase similarity score using the key-phrase cross encoder to cross-encoder the second key-phrase and third key-phrase; and
storing, in association with the triplet, the first key-phrase, the second key-phrase, the third key-phrase, the query-document chunk key phrase similarity score, the response-document chunk key phrase similarity score and the response-document chunk key phrase similarity score.

20. One or more non-transitory computer readable media comprising instructions which, when executed by one or more hardware processors, cause performance of operations comprising:
accessing a triplet comprising a plurality of components including: a query, a document chunk, and a response, the response including content based on: an output generated by a language model in response to the query;
extracting a first key-phrase from a first component of the triplet;
extracting a second key-phrase from a different component of the triplet;
generating a summary of the document chunk;
generating a key-phrase similarity score using a key-phrase cross encoder to cross-encode the first key-phrase and the second key-phrase into the key-phrase similarity score;
scoring the summary using a summary cross encoder to generate a summary similarity score; and
generating feedback data for the output based on the key-phrase similarity score and the summary similarity score.
